(19) United States
(12) Patent Application Publication
(10) Pub. No.: US 2023/0303786 A1
(43) Pub. Date: Sep. 28, 2023

(54) ULTRA-HIGH MODULUS AND HIGH-TRANSMITTANCE POLYIMIDE THIN FILM, AND PREPARATION METHOD AND APPLICATION THEREFOR

(71) Applicants: RAYITEK HI-TECH FILM COMPANY, LTD., SHENZHEN, Shenzhen (CN); JIAXING RAYITEK FILM TECHNOLOGY CO., LTD, Jiaxing (CN)

(72) Inventors: Zhenzhong Wang, Zhuzhou (CN); Changdan Tang, Shenzhen (CN); Zhaorong Li, Yulin (CN)

(21) Appl. No.: 18/198,304

(22) Filed: May 17, 2023

Related U.S. Application Data
(63) Continuation of application No. PCT/CN2022/110230, filed on Aug. 4, 2022.

(30) Foreign Application Priority Data
Aug. 4, 2021 (CN) 202110893327.6

(51) Int. Cl. C08J 5/18; C08G 73/10

(52) U.S. Cl. CPC C08J 5/18; C08G 73/1007; C08G 73/1039; C08G 73/1042; C08G 73/1078; C08G 73/1085; C08J 2379/08

(57) ABSTRACT

Disclosed in the present disclosure are an ultra-high modulus and high-transmittance polyimide thin film, and a preparation method and application therefor. The ultra-high modulus and high-transmittance polyimide thin film is prepared by means of mixing and dissolving polydiamine and polydianhydride in a solvent, adding an end-capping reagent, and performing polymerization reaction and imidization. The ultra-high modulus and high-transmittance polyimide thin film has an ultra-high modulus and high transmittance, and is applicable to fields such as flexible photoelectricity and aerospace, especially to a structural member, a reinforcement layer or a substrate of flexible display and transparent display.

### CROSS-REFERENCE TO RELATED APPLICATIONS

The present application is a continuation application of PCT application No. PCT/CN2022/110230 filed on Aug. 4, 2022, which claims the benefit of Chinese Patent Application No. 202110893327.6 filed on Aug. 4, 2021. The contents of all of the aforementioned applications are incorporated by reference herein in their entirety.

### TECHNICAL FIELD

The present invention belongs to the technical field of polyimide polymers, and specifically, relates to an ultra-high modulus and high-transmittance polyimide thin film, and a preparation method and application therefor.

### BACKGROUND

Because of the outstanding thermal, electrical and mechanical properties of a polyimide polymer material, the polyimide polymer material is well known and widely used in advanced technology fields such as electronics and aerospace. In recent years, with the rapid development of flexible optoelectronic technology, polyimide materials are used as flexible polymer substrates and dielectric insulating materials because of its excellent comprehensive performance, such that the polyimide materials are widely applied to the fields such as flexible optoelectronic devices and flexible printed circuit boards. In order to satisfy the processing requirements of the flexible optoelectronic devices, polyimide thin films are usually required to have ultra-high modulus properties to avoid serious problems such as deformation and warpage during processing.

For example, CN201710035593.9 discloses a high modulus polyimide fiber, and a preparation method and application therefor. The method for preparing a high modulus polyimide fiber includes: performing alkaline hydrolysis on polyimide fiber by using mixed lye, where the mixed lye is a mixed aqueous solution of potassium hydroxide and N, N-dimethylacetamide. The tensile modulus of the high modulus polyimide fiber prepared by means of the method is 120-160 GPa, fracture strength is 2000-2800 MPa, and elongation at break is 1.5-2.5%; and the high modulus polyimide fiber may be widely applied to protective clothing, electronic flexible display, aerospace composite materials, and the like. CN201810381437.2 discloses a high modulus shape memory polyimide composite material and preparation method therefor. The high modulus shape memory polyimide composite material is prepared by shape memory polyimide and carbon fiber fabric; the shape memory polyimide is prepared by diamine and dianhydride; the diamine is 2-(4-aminophenyl)-5-benzoxazolamine; and the dianhydride is 4,4′-(4,4′-isopropylidenediphenoxy) bis (phthalic anhydride). Therefore, the problems, that the storage modulus of existing shape memory polyimide is generally lower than 2 GPa at 100° C. and the modulus is generally lower than 10 MPa during glass transition at a high temperature, are solved.

With the increasing integration of microelectronic devices, high transmittance polyimide, as a flexible transparent and protective layer and a support layer material, is also indispensable. The polyimide materials are usually required to have high transmittance, so as to ensure optical requirements of the microelectronic devices during operation. For example, CN201610516528.3 discloses a method for preparing polyimide. The method includes: in a first polar solvent, causing diamine, dianhydride and an end-capping reagent to react to obtain a polyamic acid solution, where the end-capping reagent is monoanhydride containing an active functional group, and the active functional group is a functional group which may be subjected to a free radical polymerization reaction; performing imidization and purification on the polyamic acid solution, so as to obtain a polyimide prepolymer; dissolving the polyimide prepolymer into a second polar solvent, and adding a free radical initiator, so as to obtain a mixed glue solution; and curing the mixed glue solution, and performing stripping by cooling a temperature to room temperature, so as to obtain thin-film polyimide. The polyimide maintains high transparency at the transmittance greater than 80%, expanding the application of the polyimide in the field of flexible display materials.

However, conventional transparent polyimide materials have desirable optical performance, but with slight insufficient mechanical performance. Polyimide thin films with high modulus and high transmittance are one of the key materials needed in the technical field of microelectronics and flexible display today. The development of such materials can meet the increasingly urgent technological needs in the field of advanced electronics and flexible display.

### SUMMARY

The present invention is intended to provide an ultra-high modulus and high-transmittance polyimide thin film, and a preparation method and application therefor. The transmittance of the ultra-high modulus and high-transmittance polyimide thin film is greater than 75%, and an elastic modulus is greater than 8 GPa, such that the ultra-high modulus and high-transmittance polyimide thin film has good mechanical strength, which is conducive to processing and forming.

In order to implement the above objective, the present invention uses the following technical solutions.

An ultra-high modulus and high-transmittance polyimide thin film is prepared by means of mixing and dissolving polydiamine and polydianhydride in a solvent, adding an end-capping reagent, and performing polymerization reaction and imidization.

The polydiamine includes first diamine and second diamine; the first diamine includes diamine containing a halogen substituent biphenyl structure; and the second diamine includes diamine containing an amido bond or/and diamine containing a benzoxazole structure.

The polydianhydride includes first dianhydride and second dianhydride; the first dianhydride includes rigid alicyclic dianhydride; and the second dianhydride includes aromatic dianhydride with a symmetrical molecular structure.

The end-capping reagent is at least one of the polydianhydride, preferably, a dianhydride structure with better symmetry.

Preferably, the diamine containing the halogen substituent biphenyl structure includes at least one of 2,2′-bis(trifluoromethyl)benzidine (TFMB), 4,4′-diaminooctafluorobiphenyl (DAOF), 2,2′,5,5′-tetrachlorobenzidine (TCBD) or 3,3′-dichlorobenzidine, and most preferably, the TFMB.

The diamine containing the amido bond includes at least one of 4,4′-diaminobenzanilide (DABA), N,N′-(2,2′-bis(trifluoromethyl)-[1,1′-biphenyl]-4,4′-diyl)bis(4-aminobenzamide) (AB-TFMB) or bis(4-aminobenzanilide)-(9H-fluorene-9,9′-bis (4-aminophenyl) (FDA-ADA), most preferably, the DABA.

Preferably, the diamine containing the benzoxazole structure includes 2-(3-amino-phenyl)-benzooxazol-5-ylamine (5ABO), 2-(4-aminophenyl)-6-aminobenzoxazole (6ABO) or phenylene benzodioxazole diamine (PBOA), most preferably, the 5ABO.

Preferably, the rigid alicyclic dianhydride includes cyclobutane-1,2,3,4-tetracarboxylic dianhydride (CBDA), 1,2,4,5-cyclohexanetetrcarboxylic dianhydride (H-PMDA), 1,3-dimethyl-1,2,3,4-tetracalboxylic dianhydride (DM-CBDA), 1,2,3,4-tetramethyl-1,2,3,4-cyclobutanetetracarboxylic dianhydride (TM-CBDA), or norbornane-2-spiro-α-cyclopentanone-α′-spiro-2′-norbornane-5,5′,6,6′-tetracarboxylic dianhydride (CpODA), most preferably, the CBDA.

Preferably, the aromatic dianhydride with the symmetrical molecular structure includes pyromellitic dianhydride (PMDA), 3,3′,4,4′-biphenyltetracarboxylic dianhydride (BPDA), 3,3′,4,4′-benzophenonetetracarboxylic dianhydride (BTDA), or 4-[(1,3-dihydro-1,3-dioxo-5-isobenzofuranyl)oxy]-1,3-isobenzofurandione (BODA), most preferably, the BPDA.

Preferably, the solvent is at least one of N,N-dimethylacetamide, N,N-dimethylformamide, N-methyl-2-pyrrolidon, dimethyl sulfoxide, m-cresol, chloroform, tetrahydrofuran, γ-butyrolactone, or 3-methyl-N, N-dimethylpropanamide.

Preferably, a mole ratio of the amount of a total substance of the polydiamine to the amount of a total substance of the polydianhydride is 1:1; and the added amount of the end-capping reagent is 0.1-2.5% of the amount of the polydiamine.

Preferably, the ultra-high modulus and high-transmittance polyimide thin film further includes an additive and/or a filler; and further preferably, the ultra-high modulus and high-transmittance polyimide thin film includes at least one of a reaction promoter, an antioxidant, a heat stabilizer, a color conditioning agent, an antistatic agent, a tear resistant agent, a glass fiber, graphene, a carbon nanotube, an inorganic fiber, nano silica, aluminum trioxide, or calcium carbonate.

The present invention further provides a method for preparing the ultra-high modulus and high-transmittance polyimide thin film. The method includes the following steps.

At S1, polydiamine and polydianhydride are mixed and dissolved in a solvent, an end-capping reagent is added, and stirring and mixing are performed, so as to obtain a mixed solution.

At S2, a catalyst is added into the mixed solution obtained in S1, and stirring and mixing are performed, so as to obtain a precursor solution.

At S3, the precursor solution obtained in S2 is casted on a substrate, drying is performed, and part of the solvent is removed, so as to obtain a half-dried thin film.

At S4, the half-dried thin film obtained in S3 is stripped from the substrate, the half-dried thin film is stretched, imidization is performed at a high temperature, and then the ultra-high modulus and high-transmittance polyimide thin film is obtained.

Preferably, the added amount of the catalyst in S1 is 0.5-2% of the amount of the polydiamine, further preferably 0.8-1.6%, and more preferably 1.0-1.5%.

Preferably, the catalyst is at least one of pyridine, methylpyridine, 1-methylimidazole, 1,2-dimethylimidazole, quinoline, isoquinoline, 2-methylimidazole, or dimethylaminopyridine.

Preferably, drying in S3 means that drying is performed for 8-60 min at 50-180° C.

Preferably, stretching in S4 means that stretching is performed at a tensile ratio of 1-1.15; and a device for stretching is a bidirectional synchronous stretching machine. Imidization at a high temperature means that heating is continued for 1-30 min at 200-400° C. under an inert gas condition.

The present invention further provides an application of the ultra-high modulus and high-transmittance polyimide thin film.

Preferably, the ultra-high modulus and high-transmittance polyimide thin film is applicable to fields such as flexible photoelectricity and aerospace, and may be used as a structural member, a reinforcement layer or a substrate of flexible display and transparent display.

The present invention has the following beneficial effects.

In the present invention, by means of mixing the specific polydiamine and specific polydianhydride, and adding 0.1%-2.5% dianhydride monomer capping end-amino, the polyimide thin film prepared by using the mixed solution is discovered unexpectedly, good transmittance can be obtained while the polyimide thin film has an ultra-high modulus.

In addition, in the present invention, the bidirectional synchronous stretching machine is used during reaction to stretch a cast film at a ratio of 1-1.15, such that the elastic modulus of the film may be significantly increased while the transmission is guaranteed.

The polyimide thin film disclosed in the present invention is simple in preparation method and excellent in performance, and has an ultra-high modulus and good optical transmittance. The transmittance of the prepared polyimide thin film is greater than 75%, and the elastic modulus is greater than 8 GPa, such that the polyimide thin film has good mechanical strength, which is conducive to processing and forming. Therefore, the polyimide thin film may be used as a structural member, a reinforcement layer or a substrate of flexible display and transparent display in the field of flexible photoelectricity and aerospace, thereby meeting market requirements.

### DETAILED DESCRIPTION OF THE EMBODIMENTS

The implementations of the present invention are described through specific embodiments below. Those skilled in the art can easily understand advantages and effects of the present invention from content disclosed in this specification. The present invention may be implemented or applied through other various specific implementations, and various modifications and changes may be made to details in this specification based on different opinions and applications without departing from a spirit and scope of the present invention.

Before the specific implementations of the present invention are further described, it should be understood that the scope of protection of the present invention is not limited to the particular implementation solutions described below; it should be further understood that the terms used in embodiments of the present invention are intended to describe particular specific implementation solutions and are not intended to limit the scope of protection of the present invention.

When a range of values is given in the embodiments, it should be understood that both endpoints of each range of values and any of the values between the two endpoints may be selected unless otherwise stated in the present invention. Unless otherwise defined, all technical and scientific terms used herein have the same meaning as commonly understood by those of ordinary skill in the art to which the present invention belongs.

The source of raw materials used in the present invention is not limited; and if not specifically stated, the raw materials used in the present invention are ordinary commercially available products in the art.

### Embodiment 1

140 g of an N,N-dimethylacetamide solvent is added in a three-necked round-bottom flask; then 0.05 mol of TFMB and 0.05 mol of DABA are added; stirring is performed at room temperature to dissolve the diamine, and a clear solution is obtained; then 0.05 mol of BPDA and 0.05 mol of CBDA are slowly added and react with the diamine; 0.0015 mol of the CBDA is additionally added as an end-capping reagent; and then the mixture is stirred for 24 hours under a nitrogen atmosphere, so as to obtain a polyamic acid mixed solution with the viscosity being 1800 poises.

The polyamic acid mixed solution obtained above and 0.0015 mol of pyridine are stirred together, then an obtained precursor solution is casted on a polyester film, and part of the solvent is removed in an oven; the half-dried thin film is stripped from the polyester film and fixed in a bidirectional synchronous stretching machine to stretch at a tensile ratio of 1.05; and finally, process heating of maintaining 20 min at 250° C. and maintaining 15 min at 350° C. in a nitrogen oven is performed to complete imidization, oxygen concentration <100 ppm, and the obtained thin film is removed from a stretching clamp and analyzed.

### Embodiment 2

140 g of an N,N-dimethylacetamide solvent is added in a three-necked round-bottom flask; then 0.08 mol of TFMB and 0.02 mol of 5ABO are added; stirring is performed at room temperature to dissolve the diamine, and a clear solution is obtained; then 0.05 mol of BPDA and 0.05 mol of TM-CBDA are slowly added and react with the diamine; 0.0015 mol of the BPDA is additionally added as an end-capping reagent; and then the mixture is stirred for 24 hours under a nitrogen atmosphere, so as to obtain a polyamic acid mixed solution with the viscosity being 2040 poises.

The polyamic acid mixed solution obtained above and 0.0015 mol of pyridine are stirred together, then an obtained precursor solution is casted on a polyester film, and part of the solvent is removed in an oven; the half-dried thin film is stripped from the polyester film and fixed in a bidirectional synchronous stretching machine to stretch at a tensile ratio of 1.05; and finally, process heating of maintaining 20 min at 250° C. and maintaining 15 min at 350° C. in a nitrogen oven is performed to complete imidization, oxygen concentration <100 ppm, and the obtained thin film is removed from a stretching clamp and analyzed.

### Embodiment 3

140 g of an N,N-dimethylacetamide solvent is added in a three-necked round-bottom flask; then 0.05 mol of TFMB, 0.035 mol of DABA and 0.015 mol of 5ABO are added; stirring is performed at room temperature to dissolve the diamine, and a clear solution is obtained; then 0.02 mol of BPDA and 0.08 mol of CBDA are slowly added and react with the diamine; 0.0015 mol of the CBDA is additionally added as an end-capping reagent; and then the mixture is stirred for 24 hours under a nitrogen atmosphere, so as to obtain a polyamic acid mixed solution with the viscosity being 1970 poises.

The polyamic acid mixed solution obtained above and 0.0015 mol of pyridine are stirred together, then an obtained precursor solution is casted on a polyester film, and part of the solvent is removed in an oven; the half-dried thin film is stripped from the polyester film and fixed in a bidirectional synchronous stretching machine to stretch at a tensile ratio of 1.0; and finally, process heating of maintaining 20 min at 250° C. and maintaining 15 min at 350° C. in a nitrogen oven is performed to complete imidization, oxygen concentration <100 ppm, and the obtained thin film is removed from a stretching clamp and analyzed.

### Embodiment 4

140 g of an N,N-dimethylacetamide solvent is added in a three-necked round-bottom flask; then 0.05 mol of TFMB, 0.035 mol of DABA and 0.015 mol of 5ABO are added; stirring is performed at room temperature to dissolve the diamine, and a clear solution is obtained; then 0.02 mol of BPDA and 0.08 mol of CBDA are slowly added and react with the diamine; 0.0015 mol of the CBDA is additionally added as an end-capping reagent; and then the mixture is stirred for 24 hours under a nitrogen atmosphere, so as to obtain a polyamic acid mixed solution with the viscosity being 1970 poises.

The polyamic acid mixed solution obtained above and 0.0015 mol of pyridine are stirred together, then an obtained precursor solution is casted on a polyester film, and part of the solvent is removed in an oven; the half-dried thin film is stripped from the polyester film and fixed in a bidirectional synchronous stretching machine to stretch at a tensile ratio of 1.05; and finally, process heating of maintaining 20 min at 250° C. and maintaining 15 min at 350° C. in a nitrogen oven is performed to complete imidization, oxygen concentration <100 ppm, and the obtained thin film is removed from a stretching clamp and analyzed.

### Embodiment 5

140 g of an N,N-dimethylacetamide solvent is added in a three-necked round-bottom flask; then 0.05 mol of TFMB, 0.035 mol of DABA and 0.015 mol of 5ABO are added; stirring is performed at room temperature to dissolve the diamine, and a clear solution is obtained; then 0.02 mol of BPDA and 0.08 mol of CBDA are slowly added and react with the diamine; 0.0015 mol of the CBDA is additionally added as an end-capping reagent; and then the mixture is stirred for 24 hours under a nitrogen atmosphere, so as to obtain a polyamic acid mixed solution with the viscosity being 1970 poises.

The polyamic acid mixed solution obtained above and 0.0015 mol of pyridine are stirred together, then an obtained precursor solution is casted on a polyester film, and part of the solvent is removed in an oven; the half-dried thin film is stripped from the polyester film and fixed in a bidirectional synchronous stretching machine to stretch at a tensile ratio of 1.10; and finally, process heating of maintaining 20 min at 250° C. and maintaining 15 min at 350° C. in a nitrogen oven is performed to complete imidization, oxygen concentration <100 ppm, and the obtained thin film is removed from a stretching clamp and analyzed.

### Embodiment 6

140 g of an N,N-dimethylacetamide solvent is added in a three-necked round-bottom flask; then 0.05 mol of TFMB, 0.035 mol of DABA and 0.015 mol of 5ABO are added; stirring is performed at room temperature to dissolve the diamine, and a clear solution is obtained; then 0.02 mol of BPDA and 0.08 mol of CBDA are slowly added and react with the diamine; 0.0015 mol of the CBDA is additionally added as an end-capping reagent; and then the mixture is stirred for 24 hours under a nitrogen atmosphere, so as to obtain a polyamic acid mixed solution with the viscosity being 1970 poises.

The polyamic acid mixed solution obtained above and 0.0015 mol of pyridine are stirred together, then an obtained precursor solution is casted on a polyester film, and part of the solvent is removed in an oven; the half-dried thin film is stripped from the polyester film and fixed in a bidirectional synchronous stretching machine to stretch at a tensile ratio of 1.15; and finally, process heating of maintaining 20 min at 250° C. and maintaining 15 min at 350° C. in a nitrogen oven is performed to complete imidization, oxygen concentration <100 ppm, and the obtained thin film is removed from a stretching clamp and analyzed.

### Embodiment 7

140 g of an N,N-dimethylacetamide solvent is added in a three-necked round-bottom flask; then 0.05 mol of TCBD and 0.05 mol of AB-TFMB are added; stirring is performed at room temperature to dissolve the diamine, and a clear solution is obtained; then 0.02 mol of PMDA and 0.08 mol of TM-CBDA are slowly added and react with the diamine; 0.0015 mol of the PMDA is additionally added as an end-capping reagent; and then the mixture is stirred for 24 hours under a nitrogen atmosphere, so as to obtain a polyamic acid mixed solution with the viscosity being 2130 poises.

The polyamic acid mixed solution obtained above and 0.0015 mol of pyridine are stirred together, then an obtained precursor solution is casted on a polyester film, and part of the solvent is removed in an oven; the half-dried thin film is stripped from the polyester film and fixed in a bidirectional synchronous stretching machine to stretch at a tensile ratio of 1.05; and finally, process heating of maintaining 20 min at 250° C. and maintaining 15 min at 350° C. in a nitrogen oven is performed to complete imidization, oxygen concentration <100 ppm, and the obtained thin film is removed from a stretching clamp and analyzed.

### Embodiment 8

140 g of an N,N-dimethylacetamide solvent is added in a three-necked round-bottom flask; then 0.05 mol of DAOF and 0.05 mol of AB-TFMB are added; stirring is performed at room temperature to dissolve the diamine, and a clear solution is obtained; then 0.04 mol of BPDA and 0.06 mol of CBDA are slowly added and react with the diamine; 0.0015 mol of the BPDA is additionally added as an end-capping reagent; and then the mixture is stirred for 24 hours under a nitrogen atmosphere, so as to obtain a polyamic acid mixed solution with the viscosity being 1970 poises.

The polyamic acid mixed solution obtained above and 0.0015 mol of pyridine are stirred together, then an obtained precursor solution is casted on a polyester film, and part of the solvent is removed in an oven; the half-dried thin film is stripped from the polyester film and fixed in a bidirectional synchronous stretching machine to stretch at a tensile ratio of 1.05; and finally, process heating of maintaining 20 min at 250° C. and maintaining 15 min at 350° C. in a nitrogen oven is performed to complete imidization, oxygen concentration <100 ppm, and the obtained thin film is removed from a stretching clamp and analyzed.

### Embodiment 9

140 g of an N,N-dimethylacetamide solvent is added in a three-necked round-bottom flask; then 0.05 mol of TFMB, 0.03 mol of AB-TFMB and 0.02 mol of 5ABO are added; stirring is performed at room temperature to dissolve the diamine, and a clear solution is obtained; then 0.03 mol of PMDA and 0.07 mol of TM-CBDA are slowly added and react with the diamine; 0.0015 mol of the PMDA is additionally added as an end-capping reagent; and then the mixture is stirred for 24 hours under a nitrogen atmosphere, so as to obtain a polyamic acid mixed solution with the viscosity being 1790 poises.

The polyamic acid solution obtained above and 0.0015 mol of pyridine are stirred together, then an obtained precursor solution is casted on a polyester film, and part of the solvent is removed in an oven; the half-dried thin film is stripped from the polyester film and fixed in a bidirectional synchronous stretching machine to stretch at a tensile ratio of 1.05; and finally, process heating of maintaining 20 min at 250° C. and maintaining 15 min at 350° C. in a nitrogen oven is performed to complete imidization, oxygen concentration <100 ppm, and the obtained thin film is removed from a stretching clamp and analyzed.

### Embodiment 10

140 g of an N,N-dimethylacetamide solvent is added in a three-necked round-bottom flask; then 0.05 mol of TFMB, 0.03 mol of AB-TFMB and 0.02 mol of 5ABO are added; stirring is performed at room temperature to dissolve the diamine, and a clear solution is obtained; then 0.02 mol of BTDA and 0.08 mol of TM-CBDA are slowly added and react with the diamine; 0.0015 mol of the TM-CBDA is additionally added as an end-capping reagent; and then the mixture is stirred for 24 hours under a nitrogen atmosphere, so as to obtain a polyamic acid mixed solution with the viscosity being 1890 poises.

The polyamic acid mixed solution obtained above and 0.0015 mol of pyridine are stirred together, then an obtained precursor solution is casted on a polyester film, and part of the solvent is removed in an oven; the half-dried thin film is stripped from the polyester film and fixed in a bidirectional synchronous stretching machine to stretch at a tensile ratio of 1.05; and finally, process heating of maintaining 20 min at 250° C. and maintaining 15 min at 350° C. in a nitrogen oven is performed to complete imidization, oxygen concentration <100 ppm, and the obtained thin film is removed from a stretching clamp and analyzed.

### Comparative Example 1

140 g of an N,N-dimethylacetamide solvent is added in a three-necked round-bottom flask; then 0.1 mol of TFMB is added; stirring is performed at room temperature to dissolve the diamine, and a clear solution is obtained; then 0.1 mol of BPDA is slowly added and reacts with the diamine; 0.0015 mol of the BPDA is additionally added as an end-capping reagent; and then the mixture is stirred for 24 hours under a nitrogen atmosphere, so as to obtain a polyamic acid mixed solution with the viscosity being 2830 poises.

The polyamic acid mixed solution obtained above and 0.0015 mol of pyridine are stirred together, then an obtained precursor solution is casted on a polyester film, and part of the solvent is removed in an oven; the half-dried thin film is stripped from the polyester film and fixed in a bidirectional synchronous stretching machine to stretch at a tensile ratio of 1.05; and finally, process heating of maintaining 20 min at 250° C. and maintaining 15 min at 350° C. in a nitrogen oven is performed to complete imidization, oxygen concentration <100 ppm, and the obtained thin film is removed from a stretching clamp and analyzed.

### Comparative Example 2

140 g of an N,N-dimethylacetamide solvent is added in a three-necked round-bottom flask; then 0.1 mol of DABA is added; stirring is performed at room temperature to dissolve the diamine, and a clear solution is obtained; then 0.04 mol of BPDA and 0.06 mol of CBDA are slowly added and react with the diamine; 0.0015 mol of the CBDA is additionally added as an end-capping reagent; and then the mixture is stirred for 24 hours under a nitrogen atmosphere, so as to obtain a polyamic acid mixed solution with the viscosity being 2960 poises.

The polyamic acid mixed solution obtained above and 0.0015 mol of pyridine are stirred together, then an obtained precursor solution is casted on a polyester film, and part of the solvent is removed in an oven; the half-dried thin film is stripped from the polyester film and fixed in a bidirectional synchronous stretching machine to stretch at a tensile ratio of 1.05; and finally, process heating of maintaining 20 min at 250° C. and maintaining 15 min at 350° C. in a nitrogen oven is performed to complete imidization, oxygen concentration <100 ppm, and the obtained thin film is removed from a stretching clamp and analyzed.

### Comparative Example 3

140 g of an N,N-dimethylacetamide solvent is added in a three-necked round-bottom flask; then 0.02 mol of TFMB, 0.02 mol of AB-TFMB and 0.06 mol of 5ABO are added; stirring is performed at room temperature to dissolve the diamine, and a clear solution is obtained; then 0.1 mol of TM-CBDA is slowly added and reacts with the diamine; 0.0015 mol of the TM-CBDA is additionally added as an end-capping reagent; and then the mixture is stirred for 24 hours under a nitrogen atmosphere, so as to obtain a polyamic acid mixed solution with the viscosity being 3050 poises.

The polyamic acid mixed solution obtained above and 0.0015 mol of pyridine are stirred together, then an obtained precursor solution is casted on a polyester film, and part of the solvent is removed in an oven; the half-dried thin film is stripped from the polyester film and fixed in a bidirectional synchronous stretching machine to stretch at a tensile ratio of 1.05; and finally, process heating of maintaining 20 min at 250° C. and maintaining 15 min at 350° C. in a nitrogen oven is performed to complete imidization, oxygen concentration <100 ppm, and the obtained thin film is removed from a stretching clamp and analyzed.

### Comparative Example 4

140 g of an N,N-dimethylacetamide solvent is added in a three-necked round-bottom flask; then 0.05 mol of DABA and 0.05 mol of 5ABO are added; stirring is performed at room temperature to dissolve the diamine, and a clear solution is obtained; then 0.1 mol of PMDA is slowly added and reacts with the diamine; 0.0015 mol of the PMDA is additionally added as an end-capping reagent; and then the mixture is stirred for 24 hours under a nitrogen atmosphere, so as to obtain a polyamic acid mixed solution with the viscosity being 3110 poises.

The polyamic acid mixed solution obtained above and 0.0015 mol of pyridine are stirred together, then an obtained precursor solution is casted on a polyester film, and part of the solvent is removed in an oven; the half-dried thin film is stripped from the polyester film and fixed in a bidirectional synchronous stretching machine to stretch at a tensile ratio of 1.05; and finally, process heating of maintaining 20 min at 250° C. and maintaining 15 min at 350° C. in a nitrogen oven is performed to complete imidization, oxygen concentration <100 ppm, and the obtained thin film is removed from a stretching clamp and analyzed.

### Comparative Example 5

140 g of an N,N-dimethylacetamide solvent is added in a three-necked round-bottom flask; then 0.05 mol of TCBD and 0.05 mol of AB-TFMB are added; stirring is performed at room temperature to dissolve the diamine, and a clear solution is obtained; then 0.02 mol of PMDA and 0.08 mol of TM-CBDA are slowly added and react with the diamine; and then the mixture is stirred for 24 hours under a nitrogen atmosphere, so as to obtain a polyamic acid mixed solution with the viscosity being 1830 poises.

The polyamic acid mixed solution obtained above and 0.0015 mol of pyridine are stirred together, then an obtained precursor solution is casted on a polyester film, and part of the solvent is removed in an oven; the half-dried thin film is stripped from the polyester film and fixed in a bidirectional synchronous stretching machine to stretch at a tensile ratio of 1.05; and finally, process heating of maintaining 20 min at 250° C. and maintaining 15 min at 350° C. in a nitrogen oven is performed to complete imidization, oxygen concentration <100 ppm, and the obtained thin film is removed from a stretching clamp and analyzed.

### Comparative Example 6

140 g of an N,N-dimethylacetamide solvent is added in a three-necked round-bottom flask; then 0.05 mol of TFMB, 0.035 mol of DABA and 0.015 mol of 5ABO are added; stirring is performed at room temperature to dissolve the diamine, and a clear solution is obtained; then 0.02 mol of BPDA and 0.08 mol of CBDA are slowly added and react with the diamine; 0.0015 mol of the CBDA is additionally added as an end-capping reagent; and then the mixture is stirred for 24 hours under a nitrogen atmosphere, so as to obtain a polyamic acid mixed solution with the viscosity being 1970 poises.

The polyamic acid mixed solution obtained above and 0.0015 mol of pyridine are stirred together, then an obtained precursor solution is casted on a polyester film, and part of the solvent is removed in an oven; the half-dried thin film is stripped from the polyester film and fixed in a bidirectional synchronous stretching machine to stretch at a tensile ratio of 1.2; and finally, process heating of maintaining 20 min at 250° C. and maintaining 15 min at 350° C. in a nitrogen oven is performed to complete imidization, oxygen concentration <100 ppm, and it is discovered that the thin film is obviously fractured when the obtained thin film is removed from a stretching clamp, such that a uniform and intact PI film cannot be prepared.

### Result Detection

A method for testing the performance of a film includes the following operations.

The transmittance of a polyimide thin film is tested by using an X-rite Ci7800 spectrophotometer.

The tensile strength, elongation at break and elastic modulus of the polyimide thin film are tested by using a SHIMADZU AG-X plus, 1KN, with a testing speed being 5 mm/min; a sample has a size of 10 mm width and 15 mm long; a testing gauge length is 50 mm; and an extensometer gauge length is 20 mm. Results are shown in Table 1.

TABLE 1

| Serial Number | Polydiamine | Polydianhydride | End-capping reagent | Tensile ratio | Thickness | Transmittance | Tensile strength | Elongation at break | Elastic modulus |
|---|---|---|---|---|---|---|---|---|---|
| Embodiment 1 | TFMB:DABA=5:5 | BPDA:CBDA=5:5 | CBDA | 1.05 | 25.2 | 82.4 | 218 | 25 | 8.5 |
| Embodiment 2 | TFMB:DABO=8:2 | BPDA:TM-CBDA=5:5 | BPDA | 1.05 | 25.0 | 78.5 | 224 | 23 | 8.3 |
| Embodiment 3 | TFMB:DABA:DABO=5:3.5:1.5 | BPDA:CBDA=2:8 | CBDA | 1.0 | 24.5 | 81.7 | 223 | 28 | 8.3 |
| Embodiment 4 | TFMB:DABA:DABO=5:3.5:1.5 | BPDA:CBDA=2:8 | CBDA | 1.05 | 25.2 | 81.2 | 237 | 23 | 8.9 |
| Embodiment 5 | TFMB:DABA:DABO=5:3.5:1.5 | BPDA:CBDA=2:8 | CBDA | 1.1 | 23.8 | 81.3 | 265 | 17 | 9.4 |
| Embodiment 6 | TFMB:DABA:DABO=5:3.5:1.5 | BPDA:CBDA=2:8 | CBDA | 1.15 | 24.2 | 81.1 | 279 | 11 | 10.0 |
| Embodiment 7 | TCBD: AB-TFMB=5: 5 | PMDA:TM-CBDA=2:8 | PMDA | 1.05 | 25.1 | 77.5 | 209 | 21 | 8.4 |
| Embodiment 8 | DAOF:AB-TFMB=5: 5 | BPDA:CBDA=4:6 | BPDA | 1.05 | 24.6 | 78.6 | 218 | 18 | 8.5 |
| Embodiment 9 | TFMB:AB-TFMB:DABO=5:3:2 | PMDA:TM-CBDA=3:7 | PMDA | 1.05 | 25.5 | 80.3 | 209 | 17 | 9.2 |
| Embodiment 10 | TFMB:AB-TFMB:DABO=5:3:2 | BTDA:TM-CBDA=2:8 | TM-CBDA | 1.05 | 24.7 | 78.2 | 216 | 21 | 8.4 |
| Comparative example 1 | TFMB | BPDA | BPDA | 1.05 | 25.1 | 83.7 | 175 | 20 | 6.2 |
| Comparative example 2 | DABA | BPDA:CBDA=4:6 | CBDA | 1.05 | 25.3 | 70.7 | 221 | 22 | 8.1 |
| Comparative example 3 | TFMB:AB-TFMB:5ABO=2:2:6 | TM-CBDA | TM-CBDA | 1.05 | 24.4 | 73.8 | 231 | 19 | 8.4 |
| Comparative example 4 | DABA:DABO=5:5 | PMDA | PMDA | 1.05 | 25.5 | 50.7 | 237 | 9 | 8.2 |
| Comparative example 5 | TCBD: AB-TFMB=5: 5 | PMDA:TM-CBDA=2:8 | - | 1.05 | 25.2 | 74.2 | 201 | 20 | 8.2 |
| Comparative example 6 | TFMB:DABA:DABO=5:3.5:1.5 | BPDA:CBDA=2:8 | CBDA | 1.2 | The film is fractured, such that a uniform and intact PI film cannot be prepared. | | | | |

According to testing results of the above table, it can be learned that the transmittance of the polyimide thin film in Embodiments 1 to 9 of the present invention is greater than 75%, such that the thin film has good optical transmittance; the elastic modulus is greater than 8.0 GPa, such that high transmittance and high modulus are both achieved; and in addition, the tensile strength is greater than 200 MPa, and the elongation at break is greater than 10%, such that the thin film has good mechanical strength, thereby facilitating processing and forming.

In addition, according to Comparative example 1, it can be learned that, although the optical transmittance of the thin film prepared by the TFMB and the BPDA may reach 86%, the elastic modulus is only 6.2 GPa, which is relatively low; the modulus of the thin film prepared by a ternary system in Comparative example 4 is as high as 8.2 GPa, but the optical transmittance is only 50.7%; when the end-capping reagent is not added in Comparative example 5, the optical transmittance of the thin film is lower than 75%, which is only 74.2%; and in Comparative example 6, when the thin film is processed by using a process with a 1.2 times tensile ratio, it is discovered that the film is obviously fractured.

From the above, it can be learned that, in the polyimide thin film provided in the present invention, the diamine and the dianhydride, which have different structures, are introduced in a main-chain structure of the polyimide thin film; and at the same time, in combination with the optimization and adjustment of the stretching process, the performance of the thin film is optimized, such that the thin film has the characteristics of high transmittance and high modulus. Therefore, the thin film may be applied to a structural member, a reinforcement layer or a substrate of flexible display and transparent display in the field of flexible photoelectricity and aerospace.

The present invention is a further described above with reference to specific embodiments, but these embodiments are merely exemplary and do not constitute any limitation on the scope of the present invention. It should be understood by those skilled in the art that, modifications or replacements may be made to the details and form of the technical solutions of the present invention without departing from the spirit and scope of the present invention, but such modifications and replacements all fall within the scope of protection of the present invention.

What is claimed is:

1. An ultra-high modulus and high-transmittance polyimide thin film, prepared by means of mixing and dissolving polydiamine and polydianhydride in a solvent, adding an end-capping reagent, and performing polymerization reaction and imidization, wherein
the polydiamine comprises first diamine and second diamine, the first diamine comprises diamine containing a halogen substituent biphenyl structure, and the second diamine comprises diamine containing an amido bond or/and diamine containing a benzoxazole structure;
the polydianhydride comprises first dianhydride and second dianhydride, the first dianhydride comprises rigid alicyclic dianhydride, and the second dianhydride comprises aromatic dianhydride with a symmetrical molecular structure; and
the end-capping reagent is at least one of the polydianhydride.

2. The ultra-high modulus and high-transmittance polyimide thin film as claimed in claim 1, wherein the diamine containing the halogen substituent biphenyl structure comprises at least one of 2,2′-bis(trifluoromethyl)benzidine, 4,4′-diaminooctafluorobiphenyl, 2,2′,5,5′-tetrachlorobenzidine or 3,3′-dichlorobenzidine;
the diamine containing the amido bond comprises at least one of 4,4′-diaminobenzanilide, N,N′-(2,2′-bis(trifluoromethyl)-[1,1′-biphenyl]-4,4′-diyl)bis(4-aminobenzamide) or bis(4-aminobenzanilide)-(9H-fluorene-9,9′-bis (4-aminophenyl); and
the diamine containing the benzoxazole structure comprises 2-(3-amino-phenyl)-benzooxazol-5-ylamine, 2-(4-aminophenyl)-6-aminobenzoxazole or phenylene benzodioxazole diamine.

3. The ultra-high modulus and high-transmittance polyimide thin film as claimed in claim 1, wherein the rigid alicyclic dianhydride comprises cyclobutane-1,2,3,4-tetracarboxylic dianhydride, 1,2,4,5-cyclohexanetetrcarboxylic dianhydride, 1,3-dimethyl-1,2,3,4-tetracalboxylic dianhydride, 1,2,3,4-tetramethyl-1,2,3,4-cyclobutanetetracarboxylic dianhydride, or norbornane-2-spiro-α-cyclopentanone-α′-spiro-2′-norbornane-5,5′,6,6′-tetracarboxylic dianhydride; and
the aromatic dianhydride with the symmetrical molecular structure comprises pyromellitic dianhydride, 3,3′,4,4′-biphenyltetracarboxylic dianhydride, 3,3′,4,4′-benzophenonetetracarboxylic dianhydride, or 4-[(1,3-dihydro-1,3-dioxo-5-isobenzofuranyl)oxy]-1,3-isobenzofurandione.

4. The ultra-high modulus and high-transmittance polyimide thin film as claimed in claim 1, wherein the solvent is at least one of N,N-dimethylacetamide, N,N-dimethylformamide, N-methyl-2-pyrrolidon, dimethyl sulfoxide, m-cresol, chloroform, tetrahydrofuran, γ-butyrolactone, or 3-methyl-N, N-dimethylpropanamide.

5. The ultra-high modulus and high-transmittance polyimide thin film as claimed in claim 1, wherein a mole ratio of the amount of a total substance of the polydiamine to the amount of a total substance of the polydianhydride is 1:1; and the added amount of the end-capping reagent is 0.1-2.5% of the amount of the polydiamine.

6. The ultra-high modulus and high-transmittance polyimide thin film as claimed in claim 1, further comprising an additive and/or a filler.

7. A method for preparing the ultra-high modulus and high-transmittance polyimide thin film as claimed in claim 1, comprising the following steps:
S1, mixing and dissolving polydiamine and polydianhydride in a solvent, adding an end-capping reagent, and performing stirring and mixing, so as to obtain a mixed solution;
S2, adding a catalyst into the mixed solution obtained in S1, and performing stirring and mixing, so as to obtain a precursor solution;
S3, pouring the precursor solution obtained in S2 on a substrate, performing drying, and removing part of the solvent, so as to obtain a half-dried thin film; and
S4, stripping the half-dried thin film obtained in S3 from the substrate, stretching the half-dried thin film, performing imidization at a high temperature, and then obtaining the ultra-high modulus and high-transmittance polyimide thin film.

8. The preparation method as claimed in claim 7, wherein, the added amount of the catalyst is 0.5-2% of the amount of the polydiamine; and
the catalyst is at least one of pyridine, methylpyridine, 1-methylimidazole, 1,2-dimethylimidazole, quinoline, isoquinoline, 2-methylimidazole, or dimethylaminopyridine.

9. The preparation method as claimed in claim 7, wherein, drying in S3 means that drying is performed for 8-60 min at 50-180° C.; stretching in S4 means that tensile ratio is performed at a tensile ratio of 1-1.15; and imidization at a high temperature means that heating is continued for 1-30 min at 200-400° C. under an inert gas condition.

10. An application of the ultra-high modulus and high-transmittance polyimide thin film as claimed in claim 1, wherein the ultra-high modulus and high-transmittance polyimide thin film is used as a structural member, a reinforcement layer or a substrate of flexible display and transparent display.
